(19) United States
(12) Patent Application Publication
(10) Pub. No.: US 2003/0140453 A1
(43) Pub. Date: Jul. 31, 2003

(54) Retractable clip for shoulder strap

(75) Inventor: Mark Jankowski, Phoenix, AZ (US)

Correspondence Address: Daniel A. Thomson, Emerson & Skeriotis, 14th Floor, One Cascade Plaza, Akron, OH, 44308-1147, US

(73) Assignee: MTD Products Inc

(21) Appl. No.: 10/157,725

(22) Filed: May 29, 2002

Related U.S. Application Data
(60) Provisional application No. 60/352,967, filed on Jan. 30, 2002.

(51) Int. Cl. E05B 1/00

(52) U.S. Cl. 16/110.1

(57) ABSTRACT

A new retractable clip for a shoulder strap is disclosed herein. The clip can be in either the extended or retracted position. The retracted position allows the clip to rest inside the handle of the outdoor power equipment. The clip is easily rotatable about the pivot point, and is easily accessible in either the extended or retracted position via the clip-groove.

### I. BACKGROUND OF THE INVENTION

A. Field of Invention

This application claims priority to U.S. Ser. No. 60/352,967, entitled RETRACTABLE CLIP FOR SHOULDER STRAP, filed Jan. 30, 2002. This invention pertains to the art of methods and apparatuses for outdoor power equipment, and more particularly to shoulder straps, and even more particularly to a retractable clip for a shoulder strap.

B. Description of the Related Art

It is known in the art for operator-carried outdoor power equipment to utilizes shoulder straps to aid the user in carrying the equipment. However, none of the existing devices utilizes a retractable clip for the shoulder strap. Currently, the shoulder strap is clipped directly to the body of the power equipment, which usually consists of a molded plastic eyelet.

The present invention provides methods and apparatuses for a retractable clip for a shoulder strap.

### II. SUMMARY OF THE INVENTION

According to one aspect of the present invention, a handle for use with associated outdoor power equipment includes a right side, a left side, a cross bar, two bases, the two bases connected together by the cross bar, connecting means for connecting the left and right sides, connecting means receivers, a clip groove, and a retractable shoulder strap clip, the clip having a clip arm, a clip stop, a clip eye, the clip arm connecting the clip stop and the clip eye, and a pivot point, the clip being pivotable about the pivot point.

In accordance with another aspect of the present invention a handle for use with associated outdoor power equipment includes a body, a clip, the clip located substantially within the body, the clip having means for receiving an associated shoulder strap, a clip stop, and a pivot point, the clip being pivotable about the pivot point.

In accordance with still another aspect of the present invention, the handle further includes a clip arm, and a clip eye, the clip arm connecting the clip stop and the clip eye, the clip eye being the means for receiving the associated shoulder strap.

In accordance with yet another aspect of the present invention the body further includes a first side, a second side, connecting means for connecting the first and second sides, a cross bar, at least two bases, the cross bar connecting the at least two bases, and a clip groove.

In accordance with another aspect of the present invention, the at least two bases are connected to an associated blower vacuum.

In accordance with still another aspect of the present invention, an apparatus for use with an associated shoulder strap includes means for receiving the associated strap, a pivot point about which the receiving means pivots, and a pivot stop to prevent full rotation of the receiving means.

In accordance with another aspect of the present invention, the receiving means is a clip having a clip arm, a clip eye, and a clip stop, the clip stop being the pivot stop.

In accordance with another aspect of the present invention, the apparatus further comprises a handle having a first side, a second side, connecting means for connecting the first and second sides, a cross bar, at least two bases, the cross bar connecting the at least two bases, and a clip groove.

In accordance with yet another aspect of the present invention, a method for utilizing a shoulder strap with an associated piece of equipment includes the steps of providing a handle, providing a clip stop, providing a clip, the clip located substantially within the handle, providing a pivot point, the clip receiving the associated shoulder strap, pivoting the clip about the pivot point, and stopping the pivoting with the clip stop.

In accordance with another aspect of the present invention, providing a clip further includes providing clip having a clip arm and a clip eye, the clip arm connecting the clip stop and the clip eye, the clip eye being the means for receiving the associated shoulder strap.

In accordance with another aspect of the present invention, providing a handle further includes providing a handle having a first side, a second side, connecting means for connecting the first and second sides, a cross bar, at least two bases, the cross bar connecting the at least two bases, and a clip groove.

In accordance with yet another aspect of the present invention, the method further includes connecting the at least two bases to an associated outdoor power equipment.

In accordance with another aspect of the present invention, connecting the at least two bases to an associated outdoor power equipment further includes connecting the at least two bases to an associated blower vacuum.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is a perspective view of a handle with the clip in the retracted position;

FIG. 2 is a side view of the handle with the clip in the retracted position;

FIG. 3 is a cross-section side view of the handle with the clip in the retracted position;

FIG. 4 is a perspective view of the handle with the clip in the extended position;

FIG. 5 is a side view of the handle with the clip in the extended position;

FIG. 6 is a cross-section side view of the handle with the clip in the extended position; and,

FIG. 7 is a side view of the clip.

### IV. DESCRIPTION OF THE INVENTION

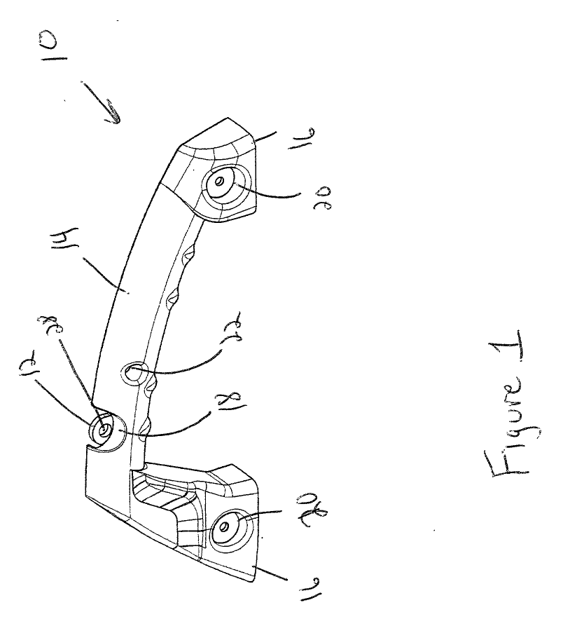

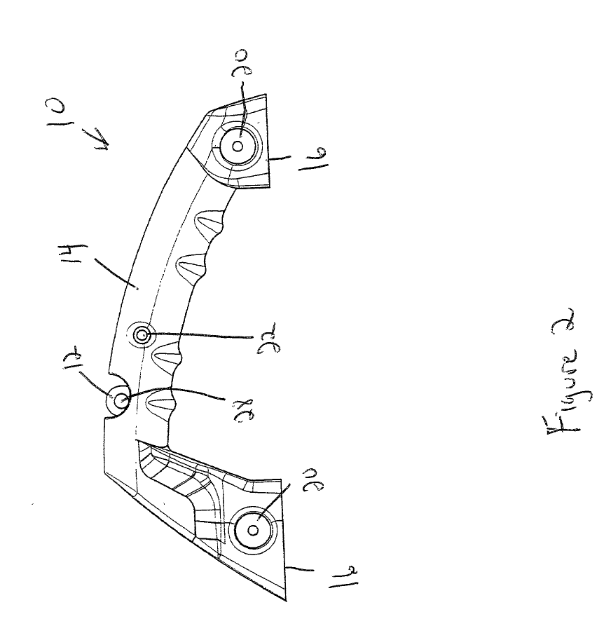

Referring now to the drawings wherein the showings are for purposes of illustrating at least one embodiment of the invention only and not for purposes of limiting the same, FIGS. 1-3 show a clip 12 in the retracted position, a handle 10, the handle 10 having a crossbar 14, two bases 16, a clip groove 18, connecting means receivers 20, the clip 12 having a clip arm 24, a clip stop 26, a clip eye 28, and a pivot 22. The two bases 16 of the handle 10 are connected to a blower vacuum (not shown). The bases 16 of the handle 10 are connected by the cross bar 14. The clip groove 18 is located in the cross bar 14 of the handle 10. The clip groove 18 allows easy access to the clip 12, when the clip 12 is in the retracted position. In this embodiment, the handle 10 has two separate pieces, a left side and a right side (only one side shown). The two sides are connected together by screws, bolts, or any other manner of connecting, as long as chosen using sound engineering judgment. The connecting means connect the two sides together through connecting means receivers 20. The handle 10 being in two pieces allows for easier manufacture and placement of the clip 12 in the handle 10.

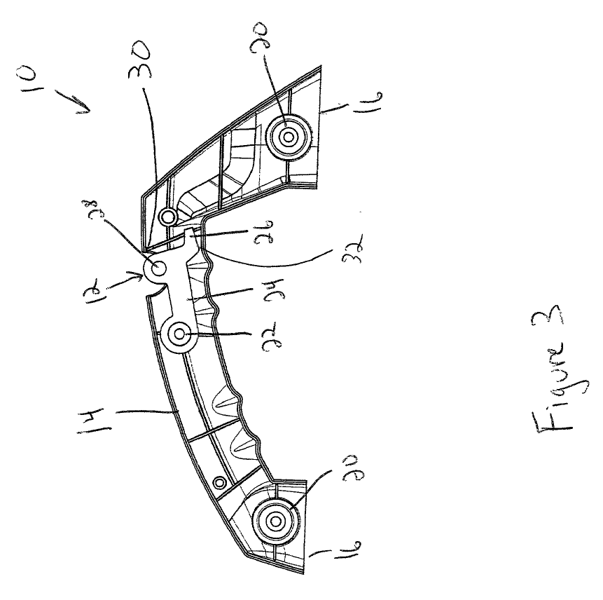

With reference now to FIG. 3, the clip 12 is located substantially within the handle 10, and is connected to the interior of the cross bar 14 at the pivot point 22. The clip 12 can rotate either upwardly, or downwardly, between top rotation point 30 and bottom rotation point 32. The clip-stop 26, as shown in FIG. 3, is in the retracted position. As the clip 12 rotates upwardly, or downwardly, between top rotation point 30 and the bottom rotation point 32, the clip-stop 26 limits the motion of the clip 12. The clip-stop 26, in the fully extended position, rests against the top rotation point 30. The handle 10 has two halves, in this embodiment, as shown in FIGS. 1-3. The two halves of the handle 10 are connected together via connecting means receivers 20, and also at the pivot point 22, as shown in FIG. 1. It is to be understood that the particular design shown in this embodiment is only intended to illustrate one of the embodiments invention, and is not intended to limit it in any manner. Any means of creating a retractable clip can be used, as long as chosen using sound engineering judgment.

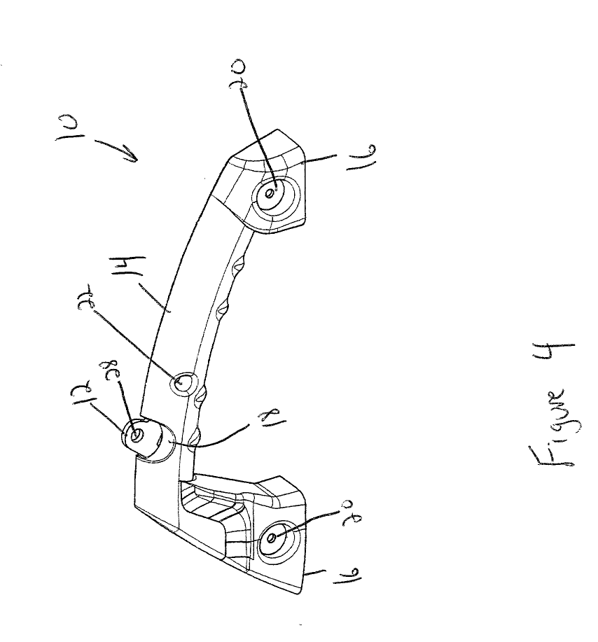

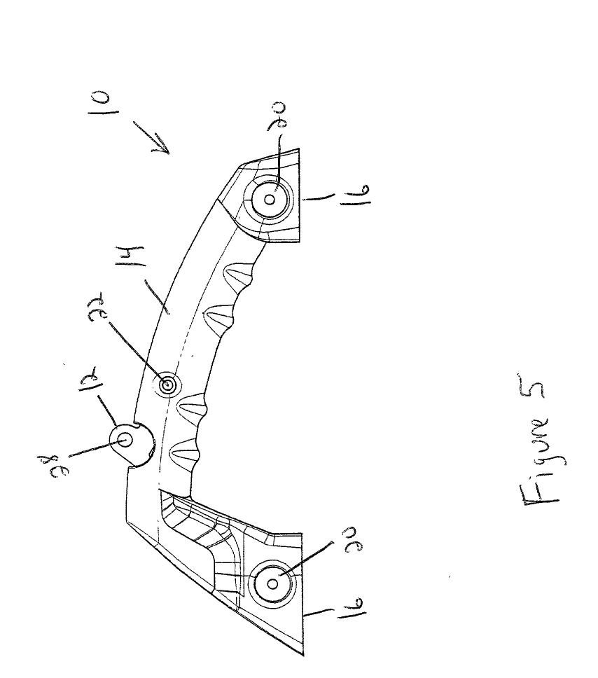

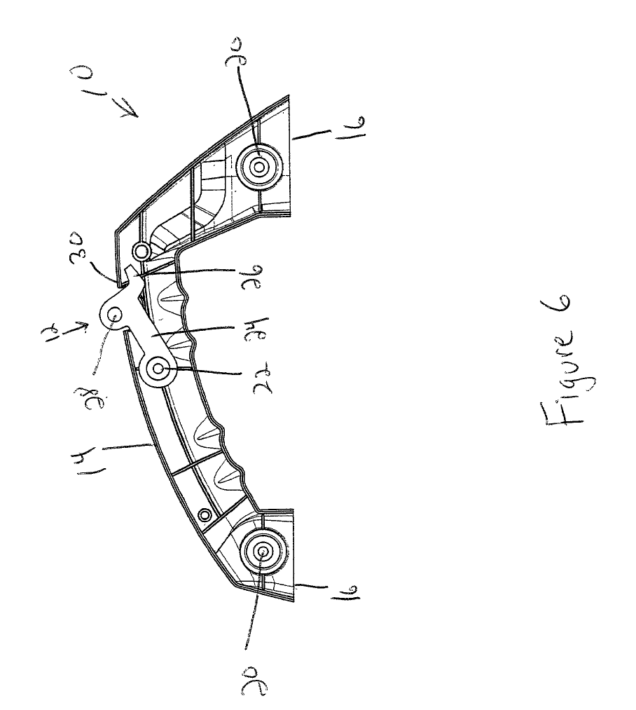

With reference now to FIGS. 4-6, the handle 10 and clip 12 are shown in the extended position. As can be seen in FIG. 6, the clip-eye 28 and the clip 12 are raised above, and outside of, the crossbar 14. As noted before, the clip 12 rotates about the pivot 22. As can be seen in FIG. 6, the clip-arm 24 and clip-stop 26 rest against crossbar 14. The clip-stop 26, in particular, rests against the top rotation point 30.

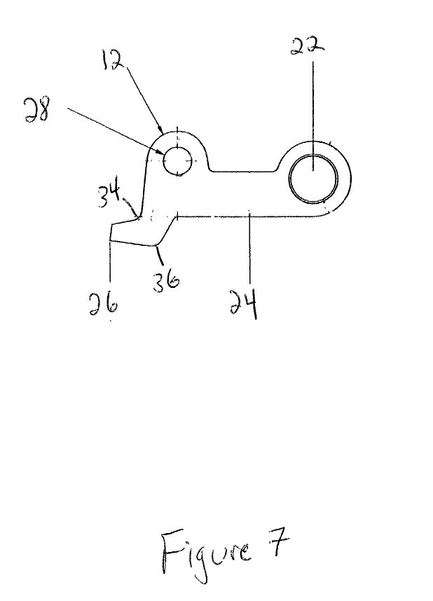

With reference now to FIGS. 3, 6, and 7, the clip 12, when in the extended position rests against the top rotation point 30 at top stop-point 34. When the clip 12 is in the retracted position, the clip 12 rests against the bottom rotation point 32 at bottom stop 36.

With reference now to FIGS. 1 and 4, the clip 12 and the clip-eye 28, are easily accessible in either the retracted or extended position, utilizing the clip-groove 18. An associated clip from a shoulder strap (not shown) can be attached to the clip 12 at clip-eye 28 via clip-groove 18. It is to be understood that any shape or design of clip could be used in this invention, as long as chosen using sound engineering judgment.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A handle for use with associated outdoor power equipment, the handle comprising:
a right side;
a left side;
a cross bar;
two bases, the two bases connected together by the cross bar;
connecting means for connecting the left and right sides;
connecting means receivers;
a clip groove; and,
a retractable shoulder strap clip, the clip comprising:
a clip arm;
a clip stop;
a clip eye, the clip arm connecting the clip stop and the clip eye; and,
a pivot point, the clip being pivotable about the pivot point.

2. A handle for use with associated outdoor power equipment, the handle comprising:
a body;
a clip, the clip located substantially within the body, the clip having means for receiving an associated shoulder strap;
a clip stop; and,
a pivot point, the clip being pivotable about the pivot point.

3. The handle of claim 2, wherein the handle further comprises:
a clip arm; and,
a clip eye, the clip arm connecting the clip stop and the clip eye, the clip eye being the means for receiving the associated shoulder strap.

4. The handle of claim 3, wherein the body further comprises:
a first side;
a second side;
connecting means for connecting the first and second sides;
a cross bar;
at least two bases, the cross bar connecting the at least two bases; and,
a clip groove.

5. The handle of claim 4, wherein the at least two bases are connected to an associated blower vacuum.

6. An apparatus for use with an associated shoulder strap, the apparatus comprising:
means for receiving the associated strap;
a pivot point about which the receiving means pivots; and,
a pivot stop to prevent full rotation of the receiving means.

7. The apparatus of claim 6, wherein the receiving means is a clip comprising:
a clip arm;
a clip eye; and,
a clip stop, the clip stop being the pivot stop.

8. The apparatus of claim 7, wherein the apparatus further comprises a handle, the handle comprising:
a first side;
a second side;
connecting means for connecting the first and second sides;
a cross bar;
at least two bases, the cross bar connecting the at least two bases; and,
a clip groove.

9. A method for utilizing a shoulder strap with an associated piece of equipment, the method comprising the steps of:
providing a handle;
providing a clip stop;
providing a clip, the clip located substantially within the handle;
providing a pivot point;
the clip receiving the associated shoulder strap;
pivoting the clip about the pivot point; and,
stopping the pivoting with the clip stop.

10. The method of claim 9, wherein providing a clip further comprises the step of:
providing clip having a clip arm and a clip eye, the clip arm connecting the clip stop and the clip eye, the clip eye being the means for receiving the associated shoulder strap.

11. The method of claim 10, wherein providing a handle further comprises the step of:
providing a handle having a first side, a second side, connecting means for connecting the first and second sides, a cross bar, at least two bases, the cross bar connecting the at least two bases, and a clip groove.

12. The method of claim 11, wherein the method further comprises the step of:
connecting the at least two bases to an associated outdoor power equipment.

13. The method of claim 12, wherein connecting the at least two bases to an associated outdoor power equipment further comprises the step of:
connecting the at least two bases to an associated blower vacuum.
